(19) United States
(12) Patent Application Publication
(10) Pub. No.: US 2022/0012631 A1
(43) Pub. Date: Jan. 13, 2022

(54) MACHINE LEARNING SYSTEM, METHOD, AND COMPUTER PROGRAM FOR MANAGING GUEST NETWORK ACCESS IN A RESIDENTIAL SPACE

(71) Applicant: Amdocs Development Limited, Limassol (CY)

(72) Inventors: Gil Rosen, Tel Mond (IL); Vivi Miranda, Raanana (IL); Gilli Shama, Ra'anana (IL); Amir Lapid, Givatayim (IL); Eytan Kabilou, Kadima (IL); Ilan Levy, Herzeliya (IL)

(21) Appl. No.: 16/925,203

(22) Filed: Jul. 9, 2020

(51) Int. Cl. G06N 20/00; H04L 12/26; G06K 9/62; G06N 5/04; H04L 12/24

(52) U.S. Cl. CPC G06N 20/00; H04L 43/04; H04L 41/02; G06K 9/6256; G06N 5/04; G06K 9/6267

(57) ABSTRACT

As described herein, a machine learning system, method, and computer program are provided for managing guest network access in a residential space. In use, network usage data is collected from a residential network router operating in a residential space. Additionally, a machine learning algorithm processes the network usage data to classify a user device connected to the residential network router as being operated by a guest of the residential space. Further, the classification is output for performing one or more related actions.

### FIELD OF THE INVENTION

The present invention relates to network access management.

### BACKGROUND

Network monitoring is a very common application of network bandwidth and usage analysis. There are several applications and products accessible to the household inhabitant. However, these products usually provide usage summaries for informational purposes and only, and furthermore do not discern between resident's network usage and guest network usage.

There is thus a need for addressing these and/or other issues associated with the prior art.

### SUMMARY

As described herein, a machine learning system, method, and computer program are provided for managing guest network access in a residential space. In use, network usage data is collected from a residential network router operating in a residential space. Additionally, a machine learning algorithm processes the network usage data to classify a user device connected to the residential network router as being operated by a guest of the residential space. Further, the classification is output for performing one or more related actions.

### BRIEF DESCRIPTION OF THE DRAWINGS

FIG. 1 illustrates a machine learning method for managing guest network access in a residential space, in accordance with one embodiment.

FIG. 2 illustrates a machine learning system for managing guest network access in a residential space, in accordance with one embodiment.

FIG. 3A illustrates components of the machine learning platform of FIG. 2, in accordance with one embodiment.

FIG. 3B illustrates a machine learning classification process for the machine learning platform of FIG. 2, in accordance with one embodiment.

FIGS. 4A-D illustrate dashboards for managing guest network access in a residential space, in accordance with one embodiment.

FIG. 5 illustrates a network architecture, in accordance with one possible embodiment.

FIG. 6 illustrates an exemplary system, in accordance with one embodiment.

### DETAILED DESCRIPTION

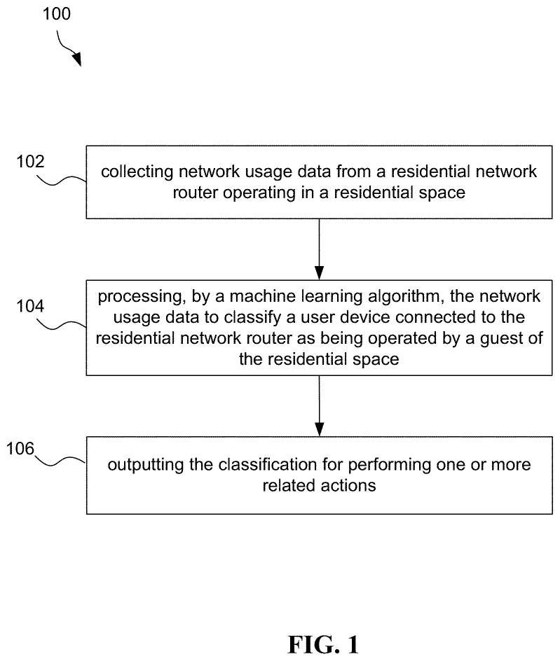

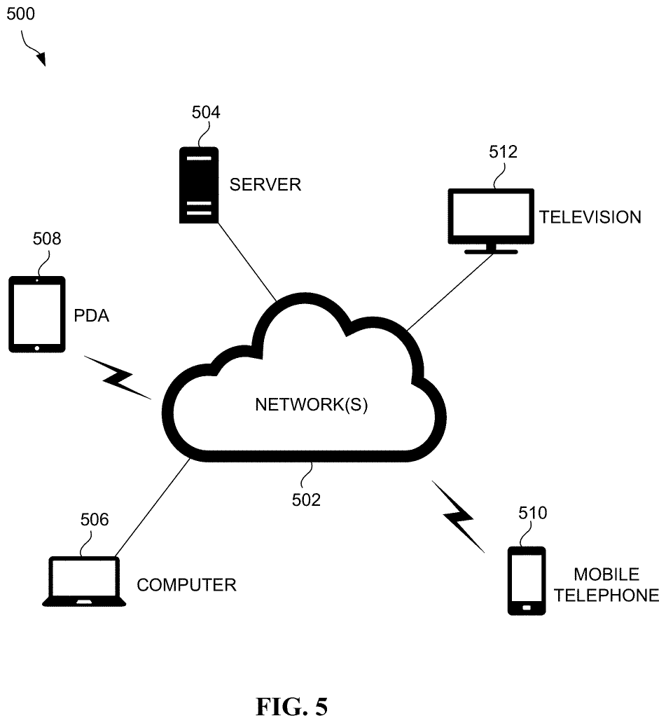

FIG. 1 illustrates a machine learning method 100 for managing guest network access in a residential space, in accordance with one embodiment. In one embodiment, the method 100 may be performed by a computer system (e.g. server) or group of computer systems, such as those described below with reference to FIGS. 5 and/or 6. For example, the method 100 may be performed by a cloud processing system in communication with the residential network router via a network. As another example, the method 100 may be performed by the residential network router itself.

As shown in operation 102, network usage data is collected from a residential network router operating in a residential space. The residential space may be a house, apartment unit, work office, or other residential unit or structure used principally for residential purposes by a substantially unchanging group of people. The residential network router is any network router that enables communication between a network (e.g. the Internet) and user devices within and possibly around the residential space. Thus, the residential network router may be located within the residential space, in one embodiment. The user devices may communicate with the residential network router via a second network, such as a local area network (LAN).

As noted above, network usage data is collected from the residential network router. The network usage data may be data indicating instances of usage of the network by users within, and possibly around, the residential space, through use of the residential network router, in one embodiment. For each of the instances of usage, the network usage data may include a time of the instance of usage, a duration of the instance of usage, an amount of the instance of usage, a user device associated with (i.e. source of) the instance of usage, a user account associated with the instance of usage, or any other data describing the usage of the network.

In one embodiment, the residential network router may be configured to communicate the network usage data in real time for the real-time collection thereof. In another embodiment, the network usage data may be collected by analyzing communications sent by the residential network router in its normal course of use by the user devices. Of course, it should be noted that the network usage data, which originates from the residential network router, may be collected in any desired manner. Further, the network usage data may be stored for processing, as described below.

Additionally, as shown in operation 104, a machine learning algorithm processes the network usage data to classify a user device connected to the residential network router as being operated by a guest of the residential space. The machine learning algorithm may be a deep learning algorithm, neural network, etc. In any case, the machine learning algorithm is trained to infer from the network usage data whether a user device connected to the residential network router is being operated by a guest of the residential space. Similarly, the machine learning algorithm may also be operable to classify a user device connected to the residential network router as being operated by a resident of the residential space, a suspected intruder to the residential space, a guest (approved or not) of the residential space, or any other type of user having one of a plurality of defined relationships with the residential space. With respect to the present description, the guest of the residential space refers to a non-resident of the residential space, such as a person that does not normally reside (e.g. with a defined regularity) within the residential space.

By way of example, the machine learning algorithm may correlate devices to users in order to classify a user device as being operated by a guest of the residential space. As a further option, the machine learning algorithm may also processes the classification and the network usage data to infer decisions for managing usage of the residential network router by the guest of the residential space. For this option, the machine learning algorithm is trained, using manual input, to infer decisions for managing usage of the residential network router by guests of the residential space. The manual input may be received through a user interface, and may define one or more policies for managing usage of the residential network router by one or more guests. In various embodiments, the decisions may include allowing or denying the usage of the residential network router by the guest of the residential space, prioritizing the usage of the residential network router by the guest of the residential space with respect to usage of the residential network router by residents of the residential space, prioritizing usage of the residential network router by residents of the residential space with respect to usage of the residential network router by other residents of the residential space or guests of the residential space, among other decisions.

Further, as shown in operation 106, the classification is output for performing one or more related actions. In one embodiment, the classification may be output to a user interface for notifying a resident of the residential space of the guest operating the user device connected to the residential network router. As an option, the notification may indicate that the user device is unassigned to any particular user. Still yet, the notification may allow the resident to define the guest and assign the user device to the defined guest.

In another embodiment, the decisions described above may be output to a guest management application for managing usage of the residential network router by the guest of the residential space. For example, the guest management application may enforce the decisions determined by the machine learning algorithm.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

Embodiments of the present disclosure address the idea of guest management, for example in the area of Smart Home technology, and specifically for the residential router. The router in the residential home (or other residential space) accepts connections from different devices and can collect information about these devices such as their connectivity, malfunctions and some identification of their traffic. On top of that, this information can be used to identify different types of users in the home, whether these are guests or users living in the home itself.

As part of the context for embodiments described herein, the machine learning algorithm provides deductions relating to characteristics of the guests connecting to the router, and additional conclusions relating to this, such as prioritization of consumption (network usage) and more. This inference can assist in answering questions and challenges around providing the best experience to the house residents when there are multiple guests in the home, how they are prioritized, what consumption is required, and the impact on the household residents' experience.

The machine learning techniques disclosed herein are enabled, in some embodiments, by new advances in the evolution of routers, where agents are installed with the purpose of collecting specific data which can be raw, and also aggregative to some degree, for analysis. These agents are not coupled software wise to a specific router and can be installed and perform the data collection on any router. The data collected enables collecting more advanced data on the device level and their activity, from which user related activity and applicative conclusions can be done machine learning. The data collected is used as input for the machine learning algorithm and processes which are also specific in nature to the residential router space. The present embodiments utilize this data for creating machine learning based classifications for guest management with regard to a home network connection.

It should be noted that the embodiments are not constrained to home households, but may be relevant to any residential environment, such as houses, work offices, or any dwelling with stable inhabitants. Although there are several solutions for identifying end users in a public network connection, such as in a shopping-mall, one uniqueness of the present embodiments is in identifying end users with the residential network connection. The residential network connection differs in the behavior of its users, as it consists mainly of usage by stable equipment, some stationary and some not. The embodiments include the classification of the different users identified by the router, regarding their affinity to the household, such as unidentified new equipment, which are to be classified as guests or intruders. And there is also the need of filtering out neighbors and people transiting nearby.

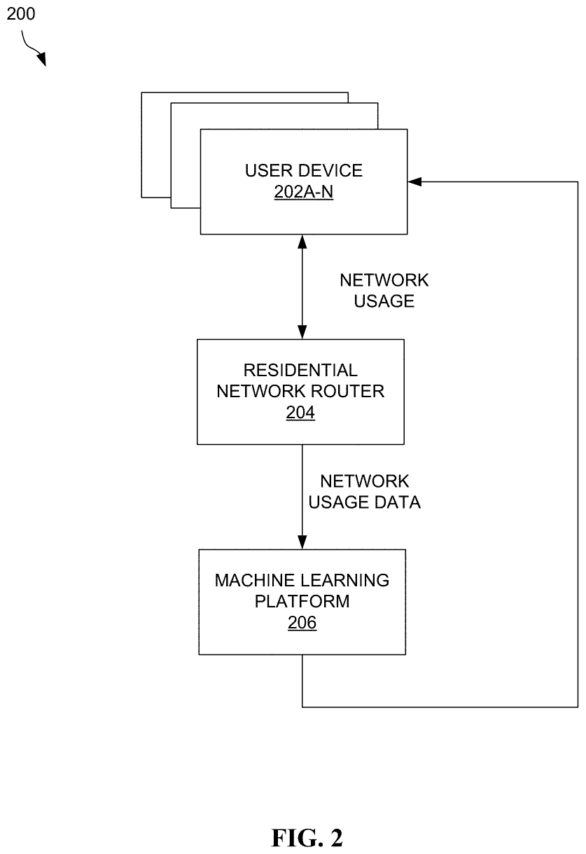

FIG. 2 illustrates a machine learning system 200 for managing guest network access in a residential space, in accordance with one embodiment. As an option, the machine learning system 200 may be implemented in the context of the details of the previous figure and/or any subsequent figure(s). Of course, however, the machine learning system 200 may be implemented in the context of any desired environment. Further, the aforementioned definitions may equally apply to the description below.

As shown, the system 200 includes at least one user device 202A-N that communicates with a residential network router 204. The user device 202A-N may be any type of end user device capable of connecting to a network via the residential network router 204. For example, the user device 202A-N may be a mobile phone, tablet, laptop computer, etc. In one embodiment, the user device 202A-N may communicate with the residential network router 204 via another network, such as a LAN.

Additionally, the system 200 includes a machine learning platform 206 in communication with the residential network router 204. The machine learning platform 206 may execute in the cloud, and thus remotely from the residential network router 204, in one embodiment. In this embodiment, the machine learning platform 206 may communicate with the residential network router 204 via the network to which the residential network router 204 provides the user device 202A-N with access. In another embodiment, the machine learning platform 206 may execute within the residential network router 204.

As shown, the user device 202A-N communicates with the residential network router 204 to access (use) the network. In turn, network usage data related to the network use by the user device 202A-N is collected from the residential network router 204 by the machine learning platform 206. The machine learning platform 206 processes the network usage data to classify a user device 202A-N connected to the residential network router 204 as being operated by a guest of the residential space, which is then output for performing one or more related actions.

As described in the following embodiments, the machine learning platform 206 may include a user interface (e.g. dashboard) enabling a user (e.g. resident of the residential space, such as a defined administrator) to admit and decline guests' connectivity, per specific guests and per timed rules, and to set consumption prioritization between guests and residents of the residential space. As also described in the following embodiments, the machine learning platform 206 may include a machine learning guests training process which continuously learns administrators' (or other residents') actions, learns the device traffic patterns and relations to specific guests, and manages the consumption in real-time, mimicking the administrators' prior decisions/actions.

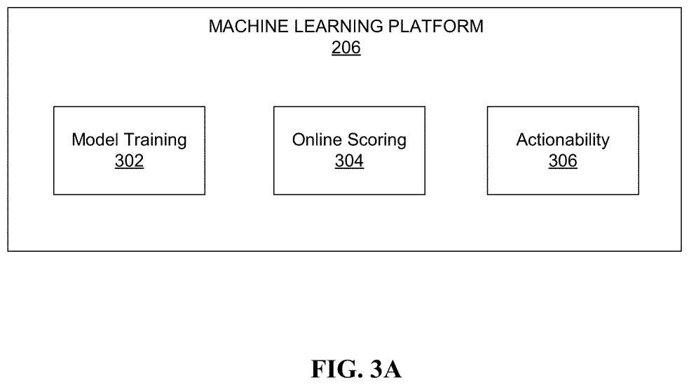

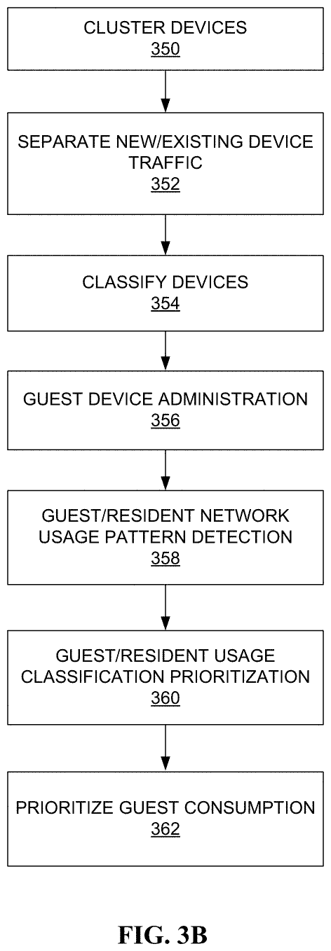

FIG. 3A illustrates components of the machine learning platform 206 of FIG. 2, in accordance with one embodiment. Of course, it should be noted that the components may be of any machine learning platform included in any desired environment. Further, the aforementioned definitions may equally apply to the description below.

As shown, the machine learning platform 206 includes a model training component 302, an online scoring component 304, and an actionability component 306. Of course, the machine learning platform 206 may also include additional components, as desired.

The model training component 302 trains/learns the model of the machine learning algorithm which classifies a user device as being operated by a guest, resident, etc. This component may include the data collection from the devices and additional classification data. The operations of the classification process described below with reference to FIG. 3B may be used as input for the model training component 302.

The online scoring component 304 includes the data collection similar to the collection process for the training of the model, according to features that have been defined as important. The online scoring component 304 also includes a periodical classification process for guest devices and guest inference, which periodically evaluates for new devices wanting to connect, but also periodically evaluate the classification of the activity for the guests. Further, the online scoring component 304 includes a consumption requirements classification, which is a periodical evaluation of consumption requirements of the guest devices and the comparison of the guest consumption requirements to tenant consumption requirements according to activity.

The actionability component 306 refers to the different actions that can be the outcome of the classification steps and the machine learning process. For example, actions may be where “local” router feedback is provided, such that operations can be executed by the residential network router, whether by the instruction of the machine learning process or the user application instructions (which are both remote to the router and go through remote processing of information). These actions may be decisions made by the machine learning process, in one embodiment.

Embodiments of the actions include:

Admittance and operations for guests—part of the administrative process for the guests once device is identified, also additional capabilities such as sharing password, malfunction detection can be enabled;

Prioritization of guests versus household residents—real time assessment of the priority of resources for the guests vs. those that the residents require as a recommendation to the user; and

The user can also instruct the machine learning platform 206 to fully decide on the priority automatically (pilot mode) but on the other hand, the user can provide input (e.g. define a device, classify as guest and manually prioritize). These inputs can override the classification recommendations of the machine learning platform 206, as well as provide input for the machine learning algorithm to adapt to them (supplying reliable labeling).

FIG. 3B illustrates a machine learning classification process for the machine learning platform 206 of FIG. 2, in accordance with one embodiment. Of course, however, the machine learning classification process may be carried out in the context of any desired environment. Further, the aforementioned definitions may equally apply to the description below.

The present embodiment relates to a classification process of the machine learning algorithm which is built on several layers of classification models, as described below, where the technique is to classify one layer to serve the next layer. Some of the classification process is relevant to the machine learning training process and some it to the real time online scoring classification.

As first, there is a data collection phase, which is ongoing, collecting information from the residential network router about the devices, its definition and additional metrics such as uplink/downlink, throughput, packet, and dropped packets and errors, events related to the bandwidth, according to their frequency and timing, and additional parameters of data collection. The classification machine learning models use this data collected to process it and classify whether the device belongs to a guest or not, and then to prioritize the consumption priority for the guest according to their activity.

As shown in operation 350, devices are clustered. In one embodiment, devices are grouped/clustered by their characteristics and traffic type from data (network usage data) collection. This is performed in order to treat different devices with their unique traits, in order to better characterize the users. For example, a personal computer (PC) traffic and performance is different from a mobile phone.

Next, in operation 352, new/existing device traffic is separated. This operation includes separating traffic related to a new device connection versus existing device connections. For these purposes, labeled data is analyzed. The labeled data analysis would be achieved by getting the user to actively allow their new devices or discard deprecated ones. This would provide labels from the user, when they allow devices as user or guest, and those that were not classified would be removed. The algorithm would cluster devices, as the differences should imply whether they are guest devices that newly connected or existing ones (as well as identifying similar connection patterns such as “similar to previous phone”, “stays overnight for a week or more”). This classification would be done with a “devices” database managing the adding of new devices, removing guests after a silent period, and on that database applying unsupervised segmentation of devices, to assign a device class of whether it is a newly connected device or not.

Additionally, in operation 354, the devices are classified. The devices are classified as users/residents; versus guests; devices versus unwanted guests' devices. This is accomplished by correlating devices to users and identifying guest devices. On a periodical basis, it may be identified whether the device is a guest device or belongs to a household resident. Every predefined time period, it may be determined if the guest device is still connected or the guest has left. In addition, unwanted guests may be identified, including devices that connect, or try to connect, to the router in pirate, and if a device was refused, there may be an alert on it to the household owner/resident.

Based on this output, the machine learning algorithm classifies devices as the following categories, which feed alerts and other guest management applications:

I. Home permanent equipment

II. Home tenants' mobile equipment

III. Neighbors permanent and mobile equipment

IV. Guests mobile equipment

V. Suspected intruders' mobile equipment

Further, in operation 356, guest device administration is performed. Initially, when the guest device is identified it should be admitted to connect to the router, as well additional administrative operations, such as sharing a password, etc. can be done once classified as a guest device. In addition, considering patterns of numbers of guests and number of users, this is where the machine learning algorithm may classify whether there is an unusual number of devices detected (for example a party), and based on that to provide a notification to the resident, or if decided by the resident to run in “auto pilot”, then to let the machine learning algorithm decide on the admittance to the router or moving them to a guest zone waiting to be admitted or even blocking them in case of unwanted amount of guests or inability to support the number.

In operation 358, guest/resident network usage pattern detection is performed. This is accomplished according to previous connections and mostly by pattern detection of the data footprint of the guest. Equipment pattern of connectivity is used to identify between the equipment types noted above. Labeled data is collected from users that marked equipment per the types above, and their connectivity pattern is collected.

Machine learning classifies new equipment to one of the types as mentioned above, based on similarity to the labeled data. A rule-based solution for example may identify an equipment that is under network connection coverage area in a high frequency, but that does not connect to the residential network as neighbors equipment, and may remember an equipment that once connected to the network with password, and then rarely repeated connection as a guest.

Machine learning expands and refines such rules based on labeled data, with features like frequency of connection and time of the day. This process builds the device current pattern of consumption and updates it periodically (e.g. daily), such that the consumption and guest experience needed can be estimated and forecasted. Such classifications are according to uplink/downlink, throughput of data, Domain Name System (DNS) hits, etc. to be able to classify the type of activity the guest is doing.

This classification step may be done by separating to two parts: first, segmenting households to consumption types, and second, learn the guest pattern classifier (e.g. comparing to other guests from other households), separately for each segment. This way, there would be a classifier only within the household and only then classifying the guests' consumption using both classifiers.

Still yet, in operation 360, guest/resident usage classification prioritization is performed. This step learns from the household's previous prioritization and applies it automatically in the future. For example, it might learn the patterns of the different guests' types and prioritize those that got high priority in the past versus those that did not get high priority in the past by comparing the guest consumption pattern with the rest of the residents' device patterns, and classifying its comparative priority. By that the classification can identify the real consumption needs of the guest user according to guest activity and needs of current users.

Moreover, in operation 362, guest consumption is prioritized. According to the consumption classification of the guest, the machine learning algorithm will decide whether to prioritize guest consumption over house resident consumption. Also, a recommendation alert may be provided to the resident which can set this prioritization, or it can be led by the machine learning algorithm that then evaluates this and sets the prioritization real time. In addition, the prioritization can also reignite a guest administration process (now with actual patterns) and decide on moving guests to lobby, or blocking, if their guest consumption prioritization is low, which could be temporary according to prioritization (as the guest was initially admitted). This can be included in a notification and decided by the resident or by the system.

To this end, the present embodiments provide data collection from a residential network router, including network connection (usage) data instead of network usage and customer data collected from a Customer Service Provider (CSP).

The embodiments also provide an interactive experience for guest consumption for the household and their guests—a system that combines user input with a machine learning enhancement to provide security, flexibility and better customer experience for household residents and guests.

Further, the embodiments provide a level of inference for guest context above the monitoring of the device—monitoring of the device only collects technical data but does not provide the context of a guest, and its consumption context and perspective/standpoint and relevant prioritization.

Still yet, the embodiments can propagate to a secondary application—as the inferred patterns and status are stored in the router, it can be easily propagated to secondary applications, such as security or smart home use cases.

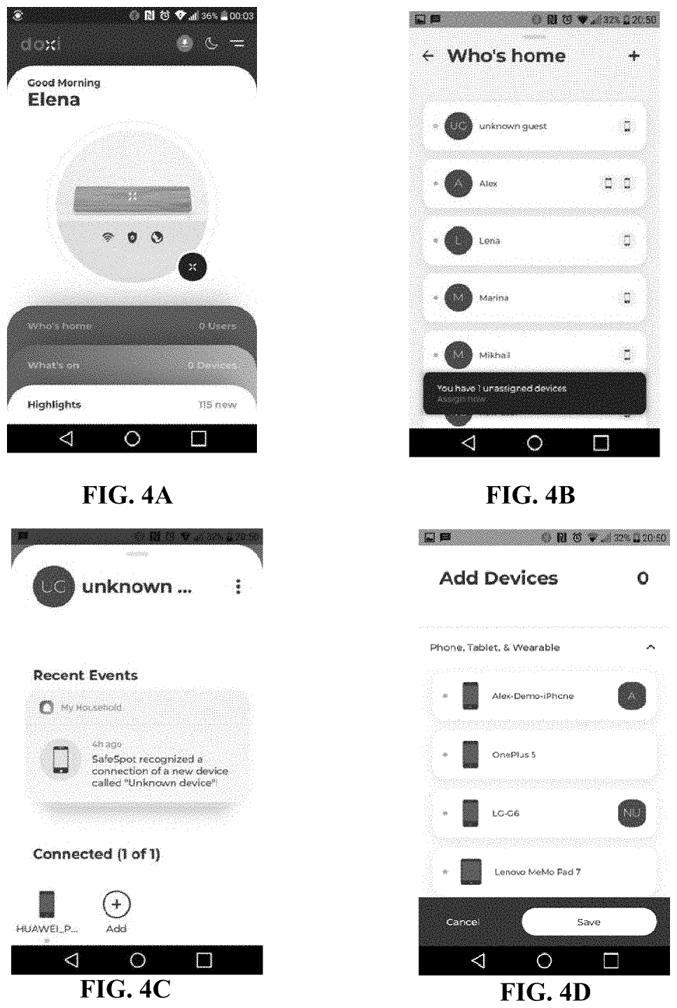

FIGS. 4A-D illustrate dashboards for managing guest network access in a residential space, in accordance with one embodiment. The dashboards may be implemented by the machine learning platform 206 of FIG. 2, in one embodiment. Of course, however, the dashboards may be implemented in the context of any desired environment. Further, the aforementioned definitions may equally apply to the description below.

The household user can go into the interface per the “Who's Home” section of FIG. 4A and review the list of devices connected as well as guests pending authorization to connect (see FIG. 4B). Under the who's home section in FIG. 4B, there is a list of connected users, along with any unassigned devices that are spotted. Where there is a notification of an unassigned device, as shown, the user can then select to assign it to a particular user (see FIG. 4C). In FIG. 4D, the device can be added and connected with the guest. To this end, the unknown device can be assigned by the household user and admitted accordingly to connect.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

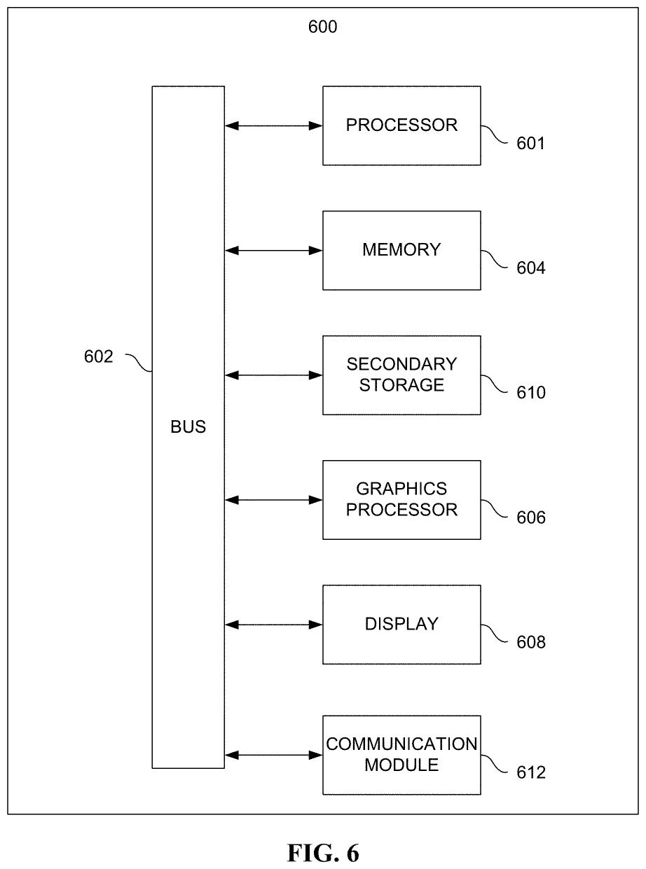

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer readable medium storing computer code executable by a processor to perform a method comprising:
collecting network usage data from a residential network router operating in a residential space;
processing, by a machine learning algorithm, the network usage data to classify a user device connected to the residential network router as being operated by a guest of the residential space; and
outputting the classification for performing one or more related actions.

2. The non-transitory computer readable medium of claim 1, wherein the network usage data is data indicating instances of usage of a network by users within the residential space.

3. The non-transitory computer readable medium of claim 2, wherein for each of the instances of usage, the network usage data includes at least one of a time of the instance of usage, a duration of the instance of usage, an amount of the instance of usage, a user device associated with the instance of usage, or a user account associated with the instance of usage.

4. The non-transitory computer readable medium of claim 1, wherein the network usage data is collected in real-time.

5. The non-transitory computer readable medium of claim 1, further comprising:
storing the network usage data.

6. The non-transitory computer readable medium of claim 1, further comprising:
presenting a user interface for receiving manual input defining one or more policies for managing usage of the residential network router by one or more guests; and
receiving, via the user interface, the manual input.

7. The non-transitory computer readable medium of claim 6, wherein the machine learning algorithm is trained, using the manual input, to infer decisions for managing usage of the residential network router by guests of the residential space.

8. The non-transitory computer readable medium of claim 7, wherein the classification is input to the machine learning algorithm to processes the classification and the network usage data to infer decisions for managing usage of the residential network router by the guest of the residential space.

9. The non-transitory computer readable medium of claim 8, wherein the decisions include allowing the usage of the residential network router by the guest of the residential space.

10. The non-transitory computer readable medium of claim 8, wherein the decisions include prioritizing the usage of the residential network router by the guest of the residential space with respect to usage of the residential network router by residents of the residential space.

11. The non-transitory computer readable medium of claim 8, wherein the decisions include prioritizing the usage of the residential network router by residents of the residential space with respect to usage of the residential network router by other residents of the residential space or guests of the residential space.

12. The non-transitory computer readable medium of claim 8, wherein the decisions are output to a guest management application for managing usage of the residential network router by the guest of the residential space.

13. The non-transitory computer readable medium of claim 1, wherein the classification is output to a user interface for notifying a resident of the residential space of the guest operating the user device connected to the residential network router.

14. The non-transitory computer readable medium of claim 13, wherein the notification indicates that the user device is unassigned to a particular user.

15. The non-transitory computer readable medium of claim 14, wherein the notification allows the resident to define the guest and assign the user device to the defined guest.

16. The non-transitory computer readable medium of claim 1, wherein the machine learning algorithm further processes the network usage data to classify at least one additional user device connected to the residential network router as being operated by a resident of the residential space.

17. The non-transitory computer readable medium of claim 1, wherein the machine learning algorithm further processes the network usage data to classify at least one additional user device connected to the residential network router as being operated by a suspected intruder to the residential space.

18. The non-transitory computer readable medium of claim 1, wherein the machine learning algorithm further processes the network usage data to classify at least one additional user device connected to the residential network router as being operated by an approved guest of the residential space.

19. The non-transitory computer readable medium of claim 1, wherein the collecting, processing, and outputting are performed by a cloud processing system in communication with the residential network router via a network.

20. The non-transitory computer readable medium of claim 1, wherein the collecting, processing, and outputting are performed by the residential network router.

21. A method, comprising:
collecting network usage data from a residential network router operating in a residential space;
processing, by a machine learning algorithm, the network usage data to classify a user device connected to the residential network router as being operated by a guest of the residential space; and
outputting the classification for performing one or more related actions.

22. A system, comprising:
a non-transitory memory storing instructions; and
one or more processors in communication with the non-transitory memory that execute the instructions to perform a method comprising:
collecting network usage data from a residential network router operating in a residential space;
processing, by a machine learning algorithm, the network usage data to classify a user device connected to the residential network router as being operated by a guest of the residential space; and
outputting the classification for performing one or more related actions.
